(19) United States
(12) Patent Application Publication
(10) Pub. No.: US 2024/0244694 A1
(43) Pub. Date: Jul. 18, 2024

(54) METHOD FOR AVOID NETWORK INTERFERENCE, ELECTRONIC DEVICE AND COMPUTER READABLE STORAGE MEDIUM

(71) Applicant: AMBIT MICROSYSTEMS (SHANGHAI) LTD., Shanghai (CN)

(72) Inventor: WEN-JIUN LIN, New Taipei (TW)

(21) Appl. No.: 18/097,806

(22) Filed: Jan. 17, 2023

(51) Int. Cl. H04W 76/16; H04B 17/345

(52) U.S. Cl. CPC H04W 76/16; H04B 17/345

(57) ABSTRACT

A method for avoid network interference executable by an electronic device is disclosed. When the electronic device is turned on, the electronic device is connected to a Wi-Fi base station through a first Wi-Fi frequency band. The electronic device operates at a short-term stage. The electronic device is connected to a mobile base station through a radio frequency band. It is determined whether the radio frequency band is a specific radio frequency band. If the radio frequency band is determined to be the specific radio frequency band, a second Wi-Fi frequency band is selected, that the electronic device can use the second Wi-Fi frequency and the radio frequency band, based on a preset table, without causing conflicts. The electronic device is connected to the Wi-Fi base station via the second Wi-Fi frequency band and operates from the short-term stage to a long-term stage.

### BACKGROUND

### Technical Field

The disclosure relates to wireless communications, and more particularly to a method for avoid network interference.

### Description of Related Art

In applications of the Wireless Wide Area Network (WWAN), wireless communication products have been widely used, and quality and stability of signals of the products are the main obstacles. The 5th generation mobile network (5G) system operates in a higher frequency band. Compared with the 4th generation (4G) Long Term Evolution (LTE) network, more small 5G base stations are required for the 5G system to cover original signal ranges.

However, more 5G base stations may interfere with Wi-Fi base stations deployed in adjacent Wireless Local Area Networks (WLANs). For example, the N79 frequency band and the B46 frequency band of the 5G New Radio (NR) and the 5 GHz frequency band of Wi-Fi will interfere with each other, in an interference called co-Existence Adjacent-Channel Interference. Therefore, how to effectively suppress the co-existing adjacent channel interference to improve system performance is an important issue.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a flowchart of an embodiment of a method for avoiding network interference of the present disclosure;

FIG. 2 is a block diagram of an embodiment of the hardware architecture of an electronic device using the method described in the flowchart in FIG. 1 of the present disclosure; and

FIG. 3 is a block diagram of an embodiment of functional blocks of an electronic device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

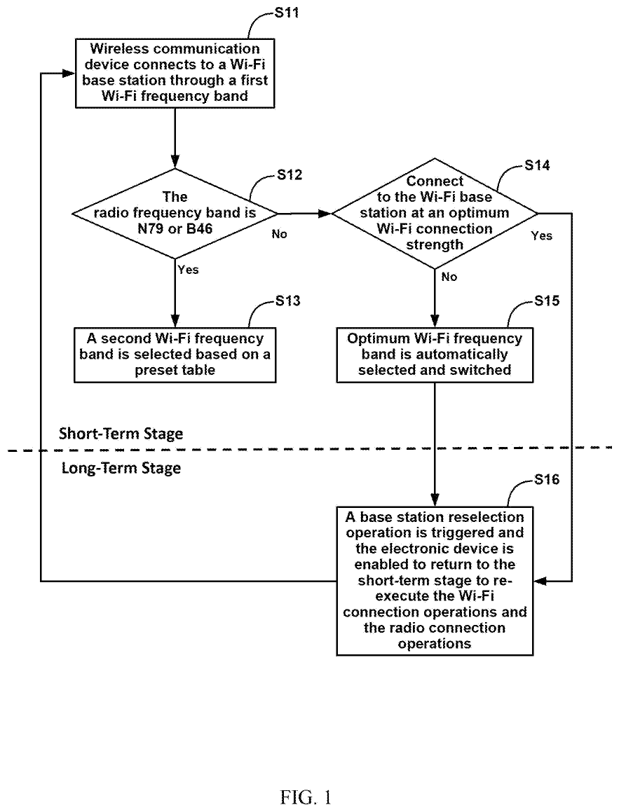

FIG. 1 is a flowchart of an embodiment of a method for avoid network interference of the present disclosure. According to different needs, the order of the steps in the flowchart can be changed, and some steps can be omitted.

In step S11, in a short-term stage, when a wireless communication device is turned on, it is connected to a Wi-Fi base station through a first Wi-Fi frequency band. The first Wi-Fi frequency band may be a frequency band related to 2.4 GHz or 5 GHz and less likely to conflict with other frequency bands.

In step S12, the wireless communication device is connected to a mobile base station through a radio frequency band and determines whether the radio frequency band is N79 or B46.

In step S13, if the radio frequency band is N79 or B46, which means that a connection conflict may occur, a second Wi-Fi frequency band which may not conflict with the N79 frequency band and the B46 frequency band is selected based on a preset table, and the wireless communication device connects to the Wi-Fi base station via the second Wi-Fi frequency band and operates from the short-term stage to a long-term stage.

In step S14, if the radio frequency band is not N79 or B46, which means that there may be no connection conflict, it is determined whether optimum Wi-Fi connection strength of the first Wi-Fi frequency band with which the Wi-Fi base station is currently connected is obtained.

In step S15, if the optimum Wi-Fi connection strength of the first Wi-Fi frequency band is not obtained, an optimum Wi-Fi frequency band, for example, a third Wi-Fi frequency band, is selected and switched, and the wireless communication device connects to the Wi-Fi base station via the third Wi-Fi frequency band and operates from the short-term stage to the long-term stage. Otherwise, if the optimum Wi-Fi connection strength of the first Wi-Fi frequency band is obtained, the wireless communication device operates from the short-term stage to the long-term stage.

In step S16, in the long-term stage, a current connection state of the wireless communication device is monitored. When the current connection state changes, such as the wireless communication device having to be connected to another mobile base station through a different radio frequency band due to moving to a different area or other reasons, a base station reselection operation (also called Cell Reselection/Handover) is triggered, and the wireless communication device returns to the short-term stage to re-execute the Wi-Fi connection and mobile connection operations.

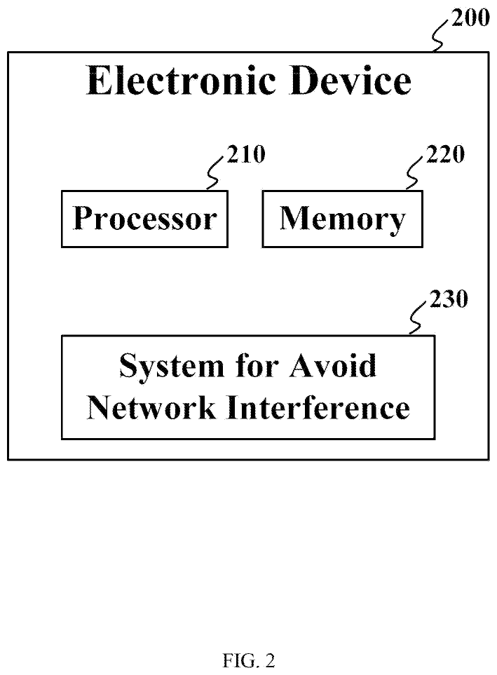

FIG. 2 is a block diagram of an embodiment of the hardware architecture of an electronic device using the method for avoid network interference of the present disclosure. The electronic device 200 may be, but is not limited to, connected to a processor 210, a memory 220, and an system for avoid network interference 230 via system buses. The electronic device 200 shown in FIG. 2 may include more or fewer components than those illustrated or may combine certain components.

The memory 220 stores a computer program, such as the system for avoid network interference 230, which is executable by the processor 210. When the processor 210 executes the system for avoid network interference 230, the blocks in one embodiment of the booting mode configuration method applied in the electronic device 200 are implemented, such as blocks S11 to S16 shown in FIG. 1.

It will be understood by those skilled in the art that FIG. 2 is merely an example of the electronic device 200 and does not constitute a limitation to the electronic device 200. The electronic device 200 may include more or fewer components than those illustrated, or may combine certain components. The electronic device 200 may also include input and output devices, network access devices, buses, and the like.

The processor 210 may be a central processing unit (CPU),or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the system for avoid network interference 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The system for avoid network interference 230 can be partitioned into one or more modules/units that are stored in the memory 220 and executed by the processor 210. The one or more modules/units may be a series of computer program instructions capable of performing particular functions of the system for avoid network interference 230.

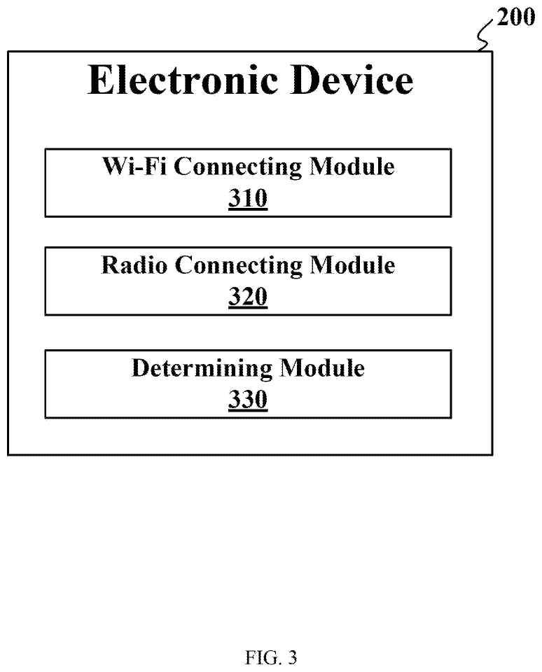

FIG. 3 is a schematic diagram of an embodiment of functional blocks of the electronic device using the method of the present disclosure.

The electronic device 200, a wireless communication device, for example, comprises a Wi-Fi connecting module 310, a radio connecting module 320 and a determining module 330.

In a short-term stage, when the electronic device 200 is turned on, the Wi-Fi connecting module 310 is connected to a Wi-Fi base station through a first Wi-Fi frequency band. The first Wi-Fi frequency band may be a frequency band related to 2.4 GHz or 5 GHz and less likely to conflict with other frequency bands.

The radio connecting module 320 is connected to a mobile base station through a radio frequency band.

The determining module 330 determines whether the radio frequency band is N79 or B46.

If the radio frequency band is N79 or B46, which means that a connection conflict may occur, the determining module 330 sends a switch command to the Wi-Fi connecting module 310. The Wi-Fi connecting module 310 selects a second Wi-Fi frequency band which may not conflict with the N79 frequency band and the B46 frequency band on a preset table according to the switch command, connects to the Wi-Fi base station via the second Wi-Fi frequency band, and enables the electronic device 200 to operate from the short-term stage to a long-term stage.

If the radio frequency band is not N79 or B46, which means that there may be no connection conflict, the Wi-Fi connecting module 310 determines whether optimum Wi-Fi connection strength of the first Wi-Fi frequency band with which the Wi-Fi base station is currently connected is obtained.

If the optimum Wi-Fi connection strength of the first Wi-Fi frequency band is not obtained, the Wi-Fi connecting module 310 selects and switches to an optimum Wi-Fi frequency band, for example, a third Wi-Fi frequency band, and is connected to the Wi-Fi base station via the third Wi-Fi frequency band. Then the determining module 330 enables the electronic device 200 to operate from the short-term stage to the long-term stage. Otherwise, if the optimum Wi-Fi connection strength of the first Wi-Fi frequency band is obtained, the determining module 330 enables the electronic device 200 to operate from the short-term stage to the long-term stage.

In the long-term stage, the determining module 330 monitors a current connection state of the electronic device 200. When the current connection state changes, such as the electronic device 200 having to be connected to another mobile base station through a different radio frequency band due to moving to a different area or other reasons, the determining module 330 triggers a base station reselection operation (also called Cell Reselection/Handover) and enables the electronic device 200 to return to the short-term stage to re-execute the Wi-Fi connection and mobile connection operations.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method for avoiding network interference, the method being executable by an electronic device and comprising:
when the electronic device is turned on, connecting the electronic device to a Wi-Fi base station through a first Wi-Fi frequency band, wherein the electronic device operates at a short-term stage;
connecting the electronic device to a mobile base station through a radio frequency band;
determining whether the radio frequency band is a specific radio frequency band;
if the radio frequency band is determined to be the specific radio frequency band, selecting a second Wi-Fi frequency band, wherein the electronic device can use the second Wi-Fi frequency and the radio frequency band, based on a preset table, without causing conflicts; and
connecting the electronic device to the Wi-Fi base station via the second Wi-Fi frequency band and enabling the electronic device to operate from the short-term stage to a long-term stage.

2. The method of claim 1, further comprising:
if the radio frequency band is not the specific radio frequency band, determining whether the electronic device is connected to the Wi-Fi base station at an optimum Wi-Fi connection strength of the first Wi-Fi frequency band.

3. The method of claim 2, further comprising:
if the electronic device is not connected to the Wi-Fi base station at the optimum Wi-Fi connection strength of the first Wi-Fi frequency band, selecting and switching to a third Wi-Fi frequency band, and connecting the electronic device to the Wi-Fi base station via the third Wi-Fi frequency band, and enabling the electronic device to operate from the short-term stage to the long-term stage.

4. The method of claim 3, further comprising:
if the electronic device is connected to the Wi-Fi base station at the optimum Wi-Fi connection strength of the first Wi-Fi frequency band, enabling the electronic device to operate from the short-term stage to the long-term stage.

5. The method of claim 4, further comprising:
in the long-term stage, monitoring a current connection state of the electronic device;
when the current connection state changes, triggering a base station reselection operation and enabling the electronic device to return to the short-term stage to re-execute the Wi-Fi connection operations and the radio connection operations.

6. An electronic device, comprising:
a Wi-Fi connecting module, configured to, when the electronic device is turned on, connect to a Wi-Fi base station through a first Wi-Fi frequency band, wherein the electronic device operates at a short-term stage;
a radio connecting module, configured to connect to a mobile base station through a radio frequency band; and
a determining module, configured to determine whether the radio frequency band is determined to be a specific radio frequency band, and, if the radio frequency band is the specific radio frequency band, ending a switch command to the Wi-Fi connecting module;
wherein, the Wi-Fi connecting module selects, according to the switch command, a second Wi-Fi frequency band, wherein the electronic device can use the second Wi-Fi frequency and the radio frequency band, based on a preset table, without causing conflicts based on a preset table, connects to the Wi-Fi base station via the second Wi-Fi frequency band, and enables the electronic device to operate from the short-term stage to a long-term stage.

7. The device of claim 6, wherein:
if the radio frequency band is not the specific radio frequency band, the Wi-Fi connecting module determines whether the electronic device is connected to the Wi-Fi base station at an optimum Wi-Fi connection strength of the first Wi-Fi frequency band.

8. The device of claim 7, wherein:
if the electronic device is not connected to the Wi-Fi base station at the optimum Wi-Fi connection strength of the first Wi-Fi frequency band is not obtained, the Wi-Fi connecting module selects and switches to a third Wi-Fi frequency band and connects to the Wi-Fi base station via the third Wi-Fi frequency band; and
the determining module enables the electronic device to operate from the short-term stage to the long-term stage.

9. The device of claim 8, wherein:
if the electronic device is connected to the Wi-Fi base station at the optimum Wi-Fi connection strength of the first Wi-Fi frequency band, the determining module enables the electronic device to operate from the short-term stage to the long-term stage.

10. The device of claim 9, wherein:
in the long-term stage, the determining module monitors a current connection state of the electronic device; and
when the current connection state changes, the determining module triggers a base station reselection operation and enables the electronic device to return to the short-term stage to re-execute the Wi-Fi connection operations and the radio connection operations.

11. A non-transitory computer-readable storage medium storing game program which causes a computer to execute:
a process of, when the electronic device is turned on, connecting the electronic device to a Wi-Fi base station through a first Wi-Fi frequency band, wherein the electronic device operates at a short-term stage;
a process of connecting the electronic device to a mobile base station through a radio frequency band;
a process of determining whether the radio frequency band is a specific radio frequency band;
a process of, if the radio frequency band is determined to be the specific radio frequency band, selecting a second Wi-Fi frequency band wherein the electronic device can use the second Wi-Fi frequency and the radio frequency band, based on a preset table, without causing conflicts; and
a process of connecting the electronic device to the Wi-Fi base station via the second Wi-Fi frequency band and enabling the electronic device to operate from the short-term stage to a long-term stage.

12. The non-transitory computer-readable storage medium of claim 11, further comprising:
a process of, if the radio frequency band is not the specific radio frequency band, determining whether the electronic device is connected to the Wi-Fi base station at an optimum Wi-Fi connection strength of the first Wi-Fi frequency band.

13. The non-transitory computer-readable storage medium of claim 12, further comprising:
a process of, if the electronic device is not connected to the Wi-Fi base station at the optimum Wi-Fi connection strength of the first Wi-Fi frequency band, selecting and switching to a third Wi-Fi frequency band, and connecting the electronic device to the Wi-Fi base station via the third Wi-Fi frequency band, and enabling the electronic device to operate from the short-term stage to the long-term stage.

14. The non-transitory computer-readable storage medium of claim 13, further comprising:
a process of, if the electronic device is connected to the Wi-Fi base station at the optimum Wi-Fi connection strength of the first Wi-Fi frequency band, enabling the electronic device to operate from the short-term stage to the long-term stage.

15. The non-transitory computer-readable storage medium of claim 14, further comprising:
a process of, in the long-term stage, monitoring a current connection state of the electronic device;
a process of, when the current connection state changes, triggering a base station reselection operation and enabling the electronic device to return to the short-term stage to re-execute the Wi-Fi connection operations and the radio connection operations.
